(19) United States
(12) Patent Application Publication
(10) Pub. No.: US 2020/0359291 A1
(43) Pub. Date: Nov. 12, 2020

(54) METHODS FOR ESTABLISHING CONNECTION FOR PACKET DATA TRANSFER OF A WIRELESS COMMUNICATION DEVICE

(71) Applicant: Telefonaktiebolaget LM Ericsson (publ), Stockholm (SE)

(72) Inventors: Peter RAMLE, Mölnlycke (SE); Aldo BOLLE, Frölunda (SE); Peter HEDMAN, Helsingborg (SE); Lars-Bertil OLSSON, Angered (SE); Paul SCHLIWA-BERTLING, Ljungsbro (SE)

(73) Assignee: Telefonaktiebolaget LM Ericsson (publ), Stockholm (SE)

(21) Appl. No.: 16/754,591

(22) PCT Filed: Oct. 9, 2017
(86) PCT No.: PCT/SE2017/050988

§ 371 Date: Apr. 8, 2020

(51) Int. Cl. H04W 36/32; H04W 48/18; H04W 8/08; H04W 48/16

(52) U.S. Cl. CPC H04W 36/32; H04W 48/16; H04W 8/08; H04W 48/18

(57) ABSTRACT

The invention relates to methods and devices establishing connection for packet data transfer of a wireless communication device and methods and devices for of enabling handover of a wireless communication device. In an aspect of the invention, a method performed by a wireless communication device (101, 201) of enabling establishing of connection for packet data transfer is provided. The method comprises transmitting (S108, S206), to a mobility management node (103, 203), during the establishment of said connection, an identifier of the established connection, and a Single Network Slice Selection Assistance Information (S-NSSAI) associated with the established connection.

### TECHNICAL FIELD

The invention relates to methods and devices establishing connection for packet data transfer of a wireless communication device and methods and devices for of enabling handover of a wireless communication device.

### BACKGROUND

In fifth generation (5G) 3rd Generation Partnership Project (3GPP) communication networks, the concept of network slicing has been proposed, where a network slice is defined as a logical network that provides specific network capabilities and network characteristics.

As part of the 5G work in 3GPP, it has been agreed that (see e.g. 3GPP TS 23.501 version 1.2.0):

Network slices may differ for supported features and network functions optimisations. The operator may deploy multiple Network Slice instances delivering exactly the same features but for different groups of wireless communication devices such as mobile phones, tablets, smart watches, etc., commonly referred to as User Equipment (UE), e.g. as they deliver a different committed service and/or because they may be dedicated to a customer.

A single UE can simultaneously be served by one or more Network Slice instances via a 5G Access Node (AN). The AMF (“Access and Mobility Management function”) instance serving the UE logically belongs to each of the Network Slice instances serving the UE, i.e. this AMF instance is common to the Network Slice instances serving a UE.

It is further defined in 3GPP TS 23.501 version 1.2.0 that a parameter referred to as Single Network Slice Selection Assistance information (S-NSSAI) identifies a Network Slice and that a network operator may provision the UE with Network Slice Selection Policy (NSSP). The NSSP includes one or more NSSP rules; each one associating an application with a certain S-NSSAI.

A default rule which matches all applications to an S-NSSAI may also be included.

It has furthermore been decided that the following types of handover shall be supported in a 5G system (5GS), see e.g. TS 23.502 version 1.0.0:
1) Intra NG (“Next Generation”) RAN (“Radio Access Network”) node,
2) Inter NG RAN node with Xn interface,
3) Intra AMF, Intra SMF (“Session Management Function”), Inter NG RAN node without Xn interface,
4) Intra AMF, Inter SMF, Inter NG RAN node without Xn interface,
5) Inter AMF, Inter and Intra SMF, Inter NG RAN node without Xn interface,
6) 5GS to EPS handover using N26 interface,
7) EPS to 5GS handover using N26 interface.

Hence, examples of handovers that shall be possible include e.g. (a) handover within 5GS, (b) handover from Evolved Packet System (EPS) to 5GS, and (c) handover from EPS to 5GS.

Current 3GPP standards do not specify the actual slices and therefore also does not specify the appropriate AMF selection at handover, from a source location that does not support slicing to a target location supporting slicing in 5GS.

Selecting any AMF (regardless of the slices supported by the AMF) serving the target location and using the same method as described in EPS (see 3GPP TS 23.401 version 15.1.0) to redirect the UE to any appropriate AMF, violates slice isolation as Packet Data Unit (PDU) sessions would be handled by non-dedicated network slices (i.e. Network Functions which are not only part of the specific network slices) until the handover procedure is concluded. The general principle for the above-mentioned EPS method is to conclude the handover procedure and then afterwards move the UE handling to a Mobility Management Entity (MME) in an appropriate Dedicated Core Network (DCN), the slicing concept in EPS, meaning that a dedicated network is only guaranteed to be used after handover is concluded.

Note, that in general, at handover, there is currently no solution to provide, from a UE to a target network, information (e.g. network slices associated to its Packet Data Network (PDN) connections/PDU sessions) needed for functions when the UE arrives in the target network, while the serving source network does not support the functions but the UE and the target network does.

An additional problem is that for a UE, not being provisioned with NSSP rules, there is no information in the UE making it possible for the UE to associate an application with an S-NSSAI (i.e. a slice). This means that such a UE will not be able to associate a PDN connection created for an application while in EPS, or a PDU session created for an application while in 5GS, with the corresponding S-NSSAI i.e. the slice identity at the target 5GS access.

### SUMMARY

An object of the invention is to solve, or at least mitigate, this problem in the art and thus to provide an improved method of enabling establishing of connection for packet data transfer for a wireless communication device.

This object is attained in a first aspect of the invention by a method performed by a wireless communication device of enabling establishing of connection for packet data transfer. The method comprises transmitting, to a mobility management node, during the establishment of the connection, an identifier of the established connection, and an S-NSSAI associated with the established connection.

This object is attained in a second aspect of the invention by a wireless communication device configured to enable establishing of connection for packet data transfer. The wireless communication device comprises a processing unit and a memory, which memory contains instructions executable by the processing unit, whereby the wireless communication device is operative to transmit, to a mobility management node, during the establishment of the connection, an identifier of the established connection, and an S-NSSAI associated with the established connection.

This object is attained in a third aspect of the invention by a method performed by a Session Management Function of enabling establishment of connection for packet data transfer of a wireless communication device. The method comprises receiving a request to establish said connection for the wireless communication device, and providing the wireless communication device, with network slicing information enabling the wireless communication device to acquire S-NSSAI associated with the connection being established.

This object is attained in a fourth aspect of the invention by a Session Management Function configured to enable establishment of connection for packet data transfer of a wireless communication device. The Session Management Function comprises a processing unit and a memory, which memory contains instructions executable by the processing unit, whereby the Session Management Function is operative to receive a request to establish said connection for the wireless communication device, and provide the wireless communication device, with network slicing information enabling the wireless communication device to acquire S-NSSAI associated with the connection being established.

This object is attained in a fifth aspect of the invention by a method of an Access and Mobility Management function (AMF) of enabling handover of a wireless communication device. The method comprises receiving a request for handover comprising a Tracking Area Identity (TAI) designating a target AMF to which the wireless communication device may be handed over, and acquiring an identifier of at least one established packet data connection to be handed over, and S-NSSAI associated with said at least one established packet data connection to be handed over.

This object is attained in a sixth aspect of the invention by a method of an Access and Mobility Management function configured to enable handover of a wireless communication device. The Access and Mobility Management function comprising a processing unit and a memory, which memory contains instructions executable by the processing unit, whereby the Access and Mobility Management function is operative to receive a request for handover comprising a TAI designating a target AMF to which the wireless communication device may be handed over, and acquire an identifier of at least one established packet data connection to be handed over, and S-NSSAI associated with said at least one established packet data connection to be handed over.

Advantageously, in an embodiment, the wireless communication device transmits, in a “transparent” data container included in an Activate Default EPS Bearer Context Accept, an EPS Bearer ID for the default bearer of the PDN connection now being established, and the S-NSSAI associated with the PDN connection. The data container is transparent in the sense that the information contained therein that is necessary (and understandable) for nodes/functions in the 5G target network to which the established PDN connection is to be handed over (e.g. an AMF or an NSSF), is not interpretable by nodes/functions in the EPS source network with which the current PDN connection is established (such as the MME or the SGW); to the EPS nodes/functions, the transparent container is merely an IE or data set data is forwarded.

For instance, the wireless communication device may be pre-provisioned with the S-NSSAI by storing it on a Universal Subscriber Identity Module (USIM) or on some other part of the terminal.

Alternatively, the wireless communication device may have received an NSSP/S-NSSAI during a previous procedure for establishing a packet data connection procedure.

Advantageously, the mechanism of providing the MME (or similarly an AMF) with the transparent container comprising at least the EPS Bearer ID and S-NSSAI enables transfer of information from the wireless communication device via the MME to a target network, to which the wireless communication device potentially will be handed over, wherein network slicing is supported by the wireless communication device and by the target network, but which slicing is not supported in the source network.

With this mechanism implemented, the source network may be of an earlier release compared to the wireless communication device and the target network, but features of a later release may advantageously be used. Nodes of the source network, e.g. the MME, do not have to understand the information comprised in the transparent container, but subsequently pass the container on to the target network upon handover.

Advantageously, in another embodiment, when the wireless communication device is to be handed over from the MME to a target AMF, the MME sends the previously received transparent container to a default AMF along with a target TAI.

As an alternative the MME may store the transparent container in a Unified Data Management (UDM) via which it is directly connected via an S6a interface (and which is connected directly to the default AMF via an N8 interface).

The default AMF subsequently relays the transparent container containing S-NSSAI(s) and also EPS bearer ID(s) to a target AMF such that the selected target AMF knows which PDN connection(s) to hand over.

Thereafter, the wireless communication device can be handed over to the target AMF.

Advantageously, a method is provided for delivering to the target AMF information regarding which network slice(s) are suitable to handle the established PDN connection(s) of the UE used in a non-slicing supporting source network (5GS/EPS/GPRS (“General Packet Radio Service”)).

This feature enables a) preserving PDU sessions/PDN connections at mobility (session continuity or service continuity), and b) that the selected target AMF is the best suited AMF to fulfil the requirement of enabling traffic isolation across slices.

Additionally, the proposed solution allows for the provisioning of network slice related information (such as the NSSP) in the UE across a non-slice-supporting network, thereby avoiding external provisioning systems.

In a seventh aspect of the invention, a computer program is provided comprising computer-executable instructions for causing a wireless communication device to perform steps recited in the method of the first aspect when the computer-executable instructions are executed on a processing unit included in the wireless communication device.

In an eighth aspect of the invention, a computer program product is provided comprising a computer readable medium, the computer readable medium having the computer program of the seventh aspect embodied thereon.

In a ninth aspect of the invention, a computer program is provided comprising computer-executable instructions for causing a Session Management Function to perform steps of the method of the third aspect when the computer-executable instructions are executed on a processing unit included in the Session Management Function.

In a tenth aspect of the invention, a computer program product is provided comprising a computer readable medium, the computer readable medium having the computer program of the ninth aspect embodied thereon.

In a eleventh aspect of the invention, a computer program is provided comprising computer-executable instructions for causing a Access and Mobility Management function to perform steps recited in the method of the fifth aspect when the computer-executable instructions are executed on a processing unit included in the wireless communication device.

In a twelfth aspect of the invention, a computer program product is provided comprising a computer readable medium, the computer readable medium having the computer program of the eleventh aspect embodied thereon.

Further embodiments will be discussed in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a signalling diagram illustrating an embodiment where establishment of a PDN connection is performed;

FIG. 2 shows a signalling diagram illustrating an embodiment where establishment of a PDU session is performed;

FIG. 3 shows a signalling diagram illustrating an embodiment where handover of a UE from a non-slice supporting EPS to a slice supporting 5GS is performed;

FIG. 4 shows a signalling diagram illustrating an embodiment where handover of a UE from non-slice supporting 5GS to slice supporting 5GS is performed;

FIG. 5 illustrates a wireless communication device according to an embodiment;

FIG. 6 illustrates a Session Management Function according to an embodiment; and

FIG. 7 illustrates an Access and Mobility Management function according to an embodiment.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

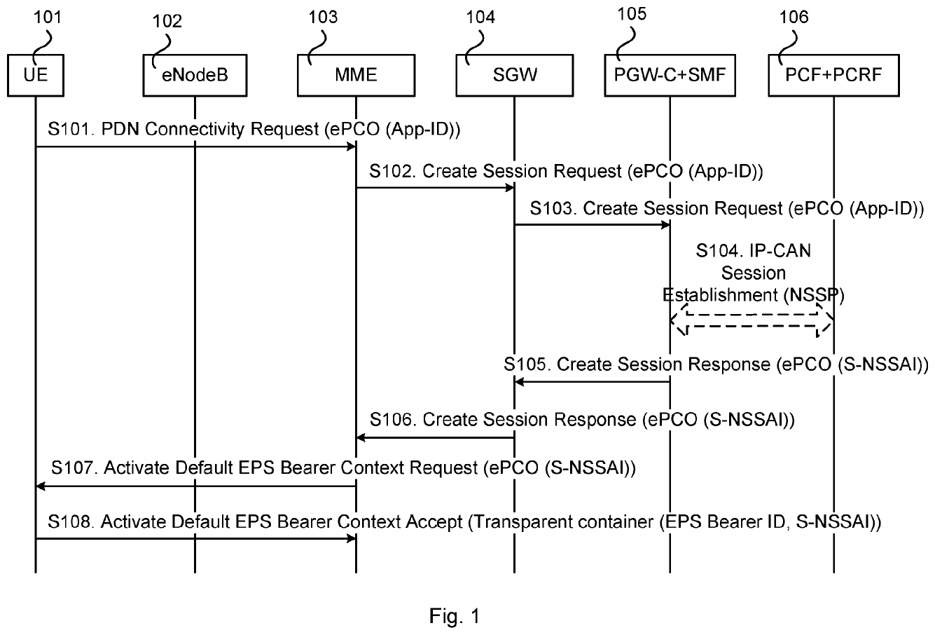

FIG. 1 shows a signalling diagram illustrating an embodiment where establishment of a PDN connection is improved in order to subsequently enable handover of a UE to a target network which supports network slicing from a source network not supporting network slicing.

For a 5GS capable UE 101 registered in EPS and either being registered in the home network or using home routed traffic, a network slice supporting PGW-C+SMF 105 (“Packet Data Network Gateway Control Plane+Session Management Function”), possibly in cooperation with a network slice supporting PCF+PCRF 106 (“Policy Control Function+Policy and Charging Rules Function”), in a source network will provide the UE 101 (via MME 103) with an S-NSSAI or an NSSP or both during PDN connection establishment.

It is noted that in FIG. 1, only parts of the PDN connection establishment procedure relevant for this embodiment are included.

In a first step S101, the UE 101 transmits via eNodeB 102 a PDN Connectivity Request to the MME 103 via an eNodeB 102 to which the UE 101 is connected. The PDN Connectivity Request may comprise an Information Element in the form of a so called evolved Protocol Configuration Option (ePCO).

In an embodiment, the ePCO optionally comprises an application identifier (App-ID), i.e. an identifier configured to identify the application that the UE 101 subsequently intends to use.

In step S102, the MME 103 transmits the App-ID within the ePCO to Serving Gateway 104 (SGW) as part of the PDN connectivity procedure, and in step S103, the SGW 104 in its turn transmits the App-ID in an ePCO to the PGW-C+SMF 105. If the PGW-C+SMF 105 is provisioned with the S-NSSAI, the App-ID may not be necessary, and the PGW-C+SMF 105 responds in step S105 by transmitting the S-NSSAI to the SGW 104.

Optionally, if dynamic Policy Control and Charging (PCC) is deployed the PGW-C+SMF 105 may employ an Internet Protocol Connectivity Access Network (IP-CAN) session establishment procedure with the PCF+PCRF 105 to acquire the NSSP for the UE 101 in step S104.

Based on the NSSP and the App-ID, the PGW-C+SMF 105 associates an S-NSSAI to the PDN connection being established, unless the PGW-C+SMF 105 already is provisioned with one or more S-NSSAIs.

Alternatively, another way of associating an S-NSSAI to the PDN connection being established is that the PGW-C+SMF 105 assigns the S-NSSAI based on subscription configuration or via PCF+PCRF 105 (e.g. via an association between Access Point Name (APN) and an App ID, and S-NSSAI).

In a further alternative, an S-NSSAI is associated with the PDN connection being established by requesting a Network Slice Selection Function (NSSF, not shown in FIG. 1) to assign the S-NSSAI for the PDN connection.

In step S105, a Create Session Response is sent to the SGW 104 comprising the S-NSSAI for the PDN connection to be established. Alternatively, the PGW-C+SMF 105 transmits the NSSP to the SGW 104.

In step S106, the SGW 104 transmits the S-NSSAI (and/or the NSSP) to the MME 103 with Create Session Response, and the MME 103 in its turn transmits the S-NSSAI (or alternatively the NSSP) to the UE 101 via the eNodeB 102 in Activate Default EPS Bearer Context Request in step S107.

Regardless of if the UE 101 has obtained the S-NSSAI via a pre-provisioned NSSP, via the received NSSP (using the Application Identifier to S-NSSAI association within the NSSP) or via the S-NSSAI in the Activate Default EPS Bearer Context Request, the UE 101 stores the S-NSSAI together with the EPS Bearer ID for the default bearer of the PDN connection to be established. In other words, the EPS Bearer ID of the default bearer identifies the PDN connection.

Finally in step S108, the UE transmits, in a “transparent” data container included in an Activate Default EPS Bearer Context Accept, an EPS Bearer ID for the default bearer of the PDN connection now being established, and the S-NSSAI associated with the PDN connection. The data container is transparent in the sense that the information contained therein that is necessary (and understandable) for nodes/functions in the 5G target network to which the established PDN connection is to be handed over (e.g. an AMF or an NSSF), is not interpretable by nodes/functions in the EPS source network with which the current PDN connection is established (such as the MME 103 or the SGW 104); to the EPS nodes/functions, the transparent container is merely an IE or data set data is forwarded.

For instance, the UE 101 may be pre-provisioned with the S-NSSAI by storing it on a Universal Subscriber Identity Module (USIM) or on some other part of the terminal.

Alternatively, the UE 101 may have received an NSSP/S-NSSAI during a previous procedure for establishing a packet data connection procedure.

As an alternative, the UE 101 provides a list of EPS Bearer ID and S-NSSAI, one tuple for each active PDN connection, in step S108.

Together with each tuple the UE 101 may also provide a priority indicator thus making it possible for the NSSF at a later stage at a change to a 5GC with slice support to select a target AMF set, based on a priority order of currently active PDN connections as determined by the UE 101, if not all active PDN connections may be served by the same AMF set at a target location.

The MME 103 stores the transparent container received at step 108 for later use.

Advantageously, the mechanism of providing the MME 103 with the transparent container comprising at least the EPS Bearer ID and S-NSSAI enables transfer of information from the UE 101 via the MME 103 to a target network, to which the UE 101 potentially will be handed over, wherein network slicing is supported by the UE and by the target network, but which slicing is not supported in the source network.

With this mechanism implemented, the source network may be of an earlier release compared to the UE 101 and the target network, but features of a later release may advantageously be used. Nodes of the source network, e.g. the MME 103, do not have to understand the information comprised in the transparent container, but subsequently pass the container on to the target network upon handover.

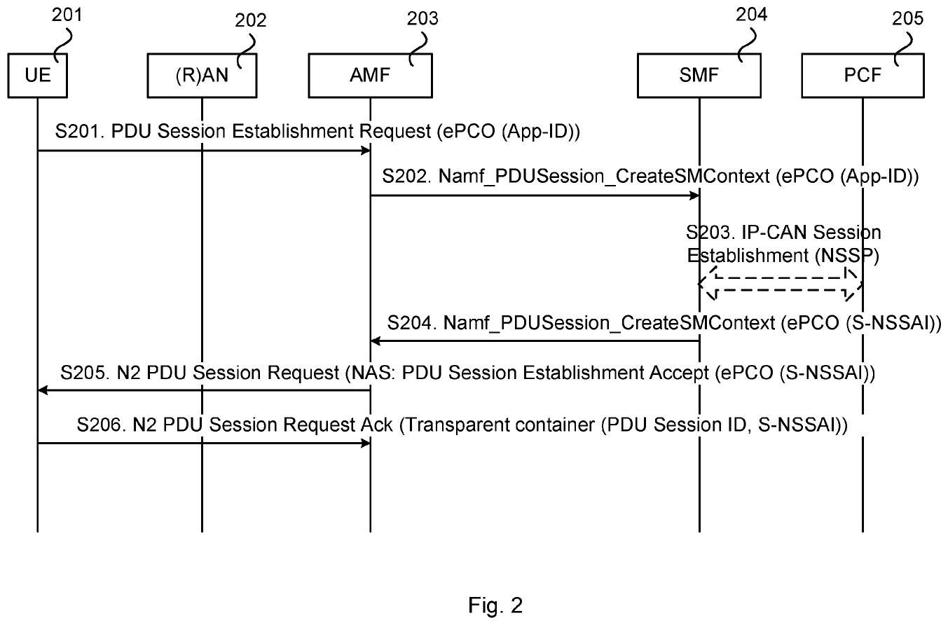

FIG. 2 shows a signalling diagram illustrating an embodiment where establishment of a PDU session is improved in order to subsequently enable handover of a UE to a target network which supports network slicing from a source network not supporting network slicing.

For a UE 201 registered in an AMF not supporting network slicing and either being registered in the home network or using home routed traffic, a network slice supporting SMF 204, possibly in cooperation with a network slice supporting PCF 205, in a source network will provide the UE 201 (via AMF 203) with an S-NSSAI or an NSSP during PDU session establishment.

It is noted that in FIG. 2, only parts of the PDU session establishment procedure relevant for this embodiment are included.

In a first step S201, the UE 201 transmits via (Radio) Access network 202 ((R)AN) to which the UE 101 is connected a PDU Session Establishment Request to the AMF 203. The PDU Session Establishment Request may comprise an Information Element in the form of a so called evolved Protocol Configuration Option (ePCO).

In an embodiment, the ePCO optionally comprises an application identifier (App-ID), i.e. an identifier configured to identify the application that the UE 201 subsequently intends to use.

In step S202, the AMF 203 transmits the App-ID within the ePCO to the SMF 204 as part of the PDU session establishment procedure. If the SMF 204 is provisioned with the S-NSSAI, the SMF 204 responds in step S204 by transmitting the S-NSSAI to the AMF 203.

Optionally, if dynamic PCC is deployed the SMF 204 may employ an IP-CAN session establishment procedure with the PCF 205 to acquire the NSSP for the UE 201 in step S203.

Based on the NSSP and the App-ID, the SMF 204 associates an S-NSSAI to the PDU session being established, unless the SMF 204 already is provisioned with the S-NSSAI.

Alternatively, another way of associating an S-NSSAI to the PDU session being established is that the SMF 204 assigns the S-NSSAI based on subscription configuration or via PCF 205 (e.g. via an association between DNN and S-NSSAI).

In a further alternative, an S-NSSAI is associated with the PDU session being established by requesting an NSSF (not shown in FIG. 2) to assign the S-NSSAI for the PDU session.

In step S204, the SMF 204 transmits the S-NSSAI for the PDU session to be established to the AMF 203. Alternatively, the SMF 204 transmits the NSSP to the AMF 203.

In step S205, the AMF 203 transmits the S-NSSAI (and/or the NSSP) to the UE 201 with an N2 PDU Session Request. It is noted that in this context, the AMF 203 does not support slicing. Hence, the S-NSSAI is sent transparently to the UE 201 in the sense that the AMF 203 does not make an interpretation of the S-NSSAI, but merely forwards it.

Regardless of if the UE 201 has obtained the S-NSSAI via a pre-provisioned NSSP, via the received NSSP (using the Application Identifier to S-NSSAI association within the NSSP) or via the S-NSSAI, the UE 201 stores the S-NSSAI together with the PDU Session ID for PDU session to be established. In other words, the PDU Session ID identifies the PDU session to which the S-NSSAI is associated.

Finally in step S206, the UE 201 transmits, in a transparent data container included in an N2 PDU Session Request Ack, the PDU Session ID for the PDU session now being established, and the S-NSSAI associated with the PDU session.

It is noted that if the UE 201 is pre-provisioned with the S-NSSAI, or the NSSP from which the S-NSSAI may be acquired, the UE 201 can transmit the transparent container comprising the PDU Session ID and the S-NSSAI for the PDN connection being established at any stage during the PDN connection establishment, such as already in step S201.

For instance, the UE 201 may be pre-provisioned with the S-NSSAI by storing it on a Universal Subscriber Identity Module (USIM) or on some other part of the terminal.

Alternatively, the UE 101 may have received an NSSP/S-NSSAI during a previous procedure for establishing a packet data connection procedure.

As an alternative, the UE 201 provides a list of PDU Session ID and S-NSSAI, one tuple for each active PDU session, in step S206.

In addition, the UE 201 may include a list of S-NSSAI for which there is no active PDU session but for which the UE later may perform a PDU session activation.

Together with each tuple (and for each single S-NSSAI value for which the PDN connection is not yet activated), the UE 201 may also provide a priority indicator thus making it possible for the NSSF at a later stage to select a target AMF set, based on a priority order of currently active PDU sessions and not yet active PDU sessions as determined by the UE 201, if not all active PDU sessions may be served by the same AMF set at a target location.

Hence, a tuple comprises S-NSSAI together with the associated PDN connection/PDU session (default EPS bearer ID/PDU session ID).

When there is no active PDN connection/PDU session there is only a prioritized S-NSSAI (and no ID).

This may be illustrated as:

| Prio | S-NSSAI | Resource |
|---|---|---|
| First | 1234 | EPS bearer ID = 5 |
| Second | 5678 | EPS bearer ID = 6 |
| Third | 90 | <no resource> |

The AMF 203 stores the transparent container for later use.

Advantageously, the mechanism of providing the AMF 203 with the transparent container comprising at least the PDU Session ID and S-NSSAI enables transfer of information from the UE 201 via the AMF 203 to a target network, to which the UE 201 potentially will be handed over, wherein network slicing is supported by the UE and by the target network, but which slicing is not supported in the source network.

With this mechanism implemented, the source network may be of an earlier release compared to the UE 201 and the target network, but features of a later release may advantageously be used. Nodes of the source network, e.g. the AMF 203, does not have to understand the information comprised in the transparent container, but subsequently pass the container on to the target network upon handover.

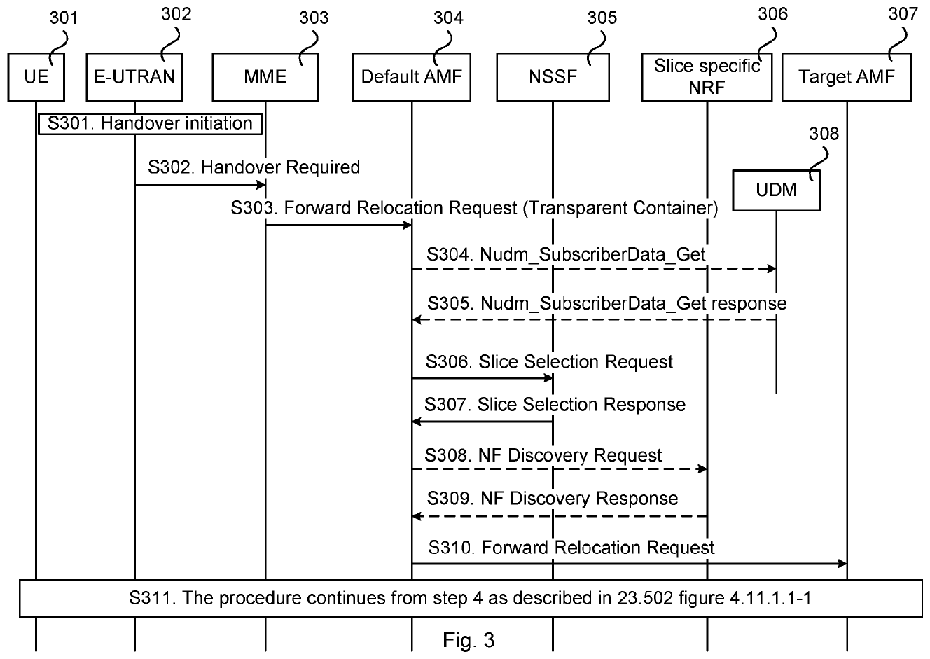

FIG. 3 shows a signalling diagram illustrating an embodiment where handover of a UE from EPS to 5GS, which supports network slicing, is improved.

After the source E-UTRAN 302 (in practice an eNodeB in the E-UTRAN) has decided that EPS-to-5GS handover of the UE 301—using the so called N26 interface between the MME 303 and the default AMF 304—is necessary in step S301, it starts the handover procedure by sending a Handover Required message to the MME 303 in step S302.

It is noted that in FIG. 3, only parts of the handover procedure relevant for this embodiment are included.

The Handover Required message sent to the MME 303 in step S302 comprises a target Tracking Area Identity (TAI) designating an AMF 307 of the target network to which the UE 301 is to be handed over.

The MME 303 selects the default AMF 304 by querying a Domain Name System (DNS) based on the target TAI. The MME 303 sends a Forward Relocation Request to the selected AMF 304. The DNS returns a reference to a “default” target AMF 304 which is a slice supporting AMF whenever such an AMF is supporting the target TAI.

Further, in the embodiment, the MME 303 includes in the Forward Relocation Request, the target TAI and the previously discussed transparent container comprising the EPS bearer ID and S-NSSAI for each active PDN connection of the UE 301 and S-NSSAI for which there is no active PDN connection yet, which container it received in step S108 and step S206 of FIG. 1 and FIG. 2 when a PDN connection/PDU session was established.

As an alternative the source MME 303 may store the transparent container in a Unified Data Management 308 (UDM) via which it is directly connected via an S6a interface (and which is connected directly to the default AMF 304 via an N8 interface).

In an embodiment, the transparent container further contains, for each S-NSSAI, a priority indicator which originates from the UE 301, the indicator giving priority to the established PDN connections as well as for PDN connections not yet established, in case these are more than one. The Forward Relocation Request message includes information for each active PDN connection, identified by the EPS Bearer ID for the default bearer. The Forward Relocation Request message may also include information S-NSSAI which is of priority for the UE but for which there is no active PDN connection.

The default AMF 304 thus receives the transparent container in step S303 (or alternatively fetches the container from the UDM 308, if the MME 303 stored the transparent container at the UDM 308) with a handover request in the form of the Forward Relocation Request.

Unless the default AMF 304 has not already received information as to which network slices the UE 301 (or rather the user) subscribes, referred to as subscribed S-NSSAI, the default AMF 304 may in an embodiment optionally turn to the UDM 308 for that information by submitting a Nudm_SubscriberData_Get Request in step S304 to which the UDM responds in step S305 with a Nudm_SubscriberData_Get Repsonse.

Alternatively, the default AMF 304 may consider all indicated S-NSSAIs as also being subscribed S-NSSAI(s).

To select a suitable target AMF set, the default AMF 304 queries the NSSF 305 in step S306 in a Slice Selection Request using the target TAI and, from the transparent container, the S-NSSAI(s) indicating slice(s) and, in an embodiment, their respective priority, as previously set by the priority indicator which originates from the UE (discussed with reference to FIGS. 1 and 2), the indicator giving priority to the S-NSSAIs, in case these are more than one.

Further, the S-NSSAI(s) to which the UE 301 (or rather the user of the UE) subscribes is provided to the NSSF 305 such that the NSSF 305 may determine if all network slices requested by the UE 301 in fact are permitted as stipulated by the user's subscription.

The priority indicator for network slice priority is helpful to the NSSF 305 in case not all (permitted) network slices in use by the UE 301 can be supported by a single AMF in the target TA.

The NSSF 305 thus selects a suitable target AMF set and indicates the AMF set to the default AMF 304 in step S307 in a Slice Selection Response. Any slice(s) not supported or permitted in the target TA are also indicated to the default AMF 304. That is, a slice the service of which cannot be supported in the target TA is a non-supported slice, while a slice not being included it the subscription of the user is a non-permitted slice.

If none of the slices in use by the UE 301 is supported and permitted in the target TA, then the handover is rejected by the default AMF 304 (a reject message is sent to the MME 303).

If the target AMF set is provided by the NSSF 305 without any addresses, the default AMF 304 may optionally turn to a slice specific NRF 306 for these addresses in step S308, which NRF 306 responds with the addresses in step S309.

In step S310, the default AMF 304 relays the Forward Relocation Request to a target AMF selected from the AMF set received with the Slice Selection Response, or at least the transparent container comprised in the Forward Relocation Request received from the MME 303, containing S-NSSAI(s) and also EPS bearer ID(s) such that the selected target AMF 307 knows which PDN connection(s) to hand over.

Further, the Forward Relocation Request at step S310 indicates which slices are supported and permitted in the target TA. That is, the S-NSSAIs of slices for which service are supported in the target TA, as well as the S-NSSAIs to which the user subscribes.

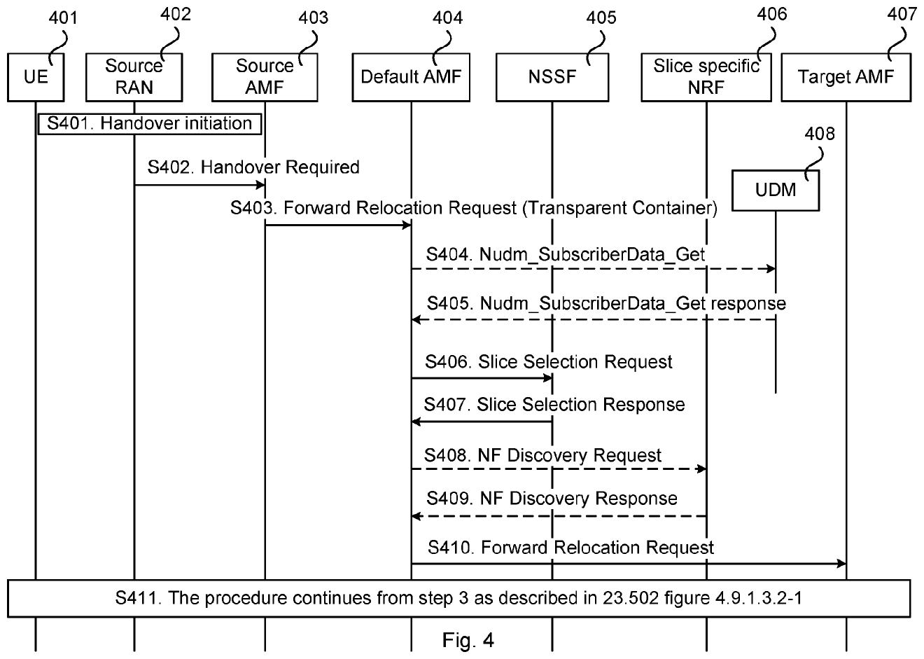

Thereafter, the UE 301 is handed over to the target AMF 307 as is performed in the art, as described e.g. from step 4 and onwards in FIG. 4.11.1.1-1 of 3GPP TS 23.502, version 1.0.0.

Advantageously, embodiments discussed with reference to FIG. 3 provide a method for delivering to the target AMF 307 information regarding which network slice(s) are suitable to handle the established PDN connection(s) of the UE 301 used in a non-slicing supporting source network (5GS/EPS/GPRS (“General Packet Radio Service”)).

This feature enables a) preserving PDU sessions/PDN connections at mobility (session continuity or service continuity), and b) that the selected target AMF 307 is the best suited AMF to fulfill the requirement of enabling traffic isolation across slices.

Additionally, the proposed solution allows for the provisioning of network slice related information (such as the NSSP) in the UE across a non-slice-supporting network, thereby avoiding external provisioning systems.

FIG. 4 shows a signalling diagram illustrating an embodiment where handover of a UE from non-slice supporting 5GS to slice supporting 5GS is improved.

After the source RAN 402 has decided that handover to a target cell in 5GS of the UE 301 is necessary in step S401, it starts the handover procedure by sending a Handover Required message to the MME 303 in step S302.

It is noted that in FIG. 4, only parts of the inter AMF handover procedure relevant for this embodiment are included.

The Handover Required message sent to the source AMF 403 in step S402 comprises a target TAI designating an AMF 407 of the target network to which the UE 401 is to be handed over.

The source AMF 403 selects the default AMF 304 by querying a Domain Name System (DNS) based on the target TAI or by using NRF. The source AMF 403 sends a Forward Relocation Request to the selected AMF 404. The DNS or NRF shall as “default” target AMF 304 provide a slice supporting AMF whenever such an AMF is supporting the target TAI.

Further, in the embodiment, the source AMF 403 includes in the Forward Relocation Request, the target TAI and the previously discussed transparent container comprising the PDU Session ID and S-NSSAI for each active PDU session of the UE 401 together with prioritized S-NSSAI for which there are no active PDU sessions, which container it received in step S108 and step S206 of FIG. 1 and FIG. 2 when a PDN connection/PDU session was established.

As an alternative the source AMF 403 may store the transparent container in a UDM 408.

In an embodiment, the transparent container further contains, for each S-NSSAI, a priority indicator which originates from the UE 401, the indicator giving priority to the established PDU session and to S-NSSAI for which there are no active PDU sessions, in case these are more than one. The Forward Relocation Request message includes information for each active PDU session, identified by the PDU Session ID.

The default AMF 404 thus receives the transparent container in step S403 (or alternatively fetches the container from the UDM 408, if the source AMF 403 stored the transparent container at the UDM 408) with a handover request in the form of the Forward Relocation Request.

Unless the default AMF 404 has not already received information as to which network slices the UE 401 (or rather the user) subscribes, referred to as subscribed S-NSSAI, the default AMF 404 may in an embodiment optionally turn to the UDM 408 for that information by submitting a Nudm_SubscriberData_Get Request in step S404 to which the UDM responds in step S405 with a Nudm_SubscriberData_Get Repsonse.

Alternatively, the default AMF 404 may consider all S-NSSAIs in use as also being subscribed S-NSSAI(s).

To select a suitable target AMF set, the default AMF 404 queries the NSSF 405 in step S406 in a Slice Selection Request using the target TAI and, from the transparent container, the S-NSSAI(s) indicating slice(s) in use and, in an embodiment, their respective priority, as previously set by the priority indicator which originates from the UE (discussed with reference to FIGS. 1 and 2), the indicator giving priority to the established PDN connections, in case these are more than one.

Further, the S-NSSAI(s) to which the UE 401 (or rather the user of the UE) subscribes is provided to the NSSF 405 such that the NSSF 405 may determine if all network slices in use by the UE 401 in fact are permitted as stipulated by the user's subscription.

The priority indicator for network slice priority is helpful to the NSSF 405 in case not all (permitted) network slices in use by the UE 401 can be supported by a single AMF in the target TA.

The NSSF 405 thus selects a suitable target AMF set and indicates the AMF set to the default AMF 404 in step S407 in a Slice Selection Response. Any slice(s) not supported or permitted in the target TA are also indicated to the default AMF 404. That is, a slice the service of which cannot be supported in the target TA is a non-supported slice, while a slice not being included it the subscription of the user is a non-permitted slice.

If none of the slices in use by the UE 401 is supported and permitted in the target TA, then the handover is rejected by the default AMF 404 (a reject message is sent to the MME 403).

If the target AMF set is provided by the NSSF 405 without any control signaling addresses to use with the target AMFs, the default AMF 404 may optionally turn to a slice specific NRF 406 for these addresses in step S408, which NRF 406 responds with the addresses in step S409.

In step S410, the default AMF 404 send a Forward Relocation Request to a target AMF 407 selected from the AMF set received with the Slice Selection Response, or at least the transparent container comprised in the Forward Relocation Request received from the source AMF 403, containing S-NSSAI(s) and also PDU Session ID(s) such that the selected target AMF 407 knows which PDU session(s) to hand over.

Further, the Forward Relocation Request indicates which slices are supported and permitted in the target TA. That is, the S-NSSAIs of slices for which service are supported in the target TA, as well as the S-NSSAIs to which the user subscribes.

Thereafter, the UE 401 is handed over to the target AMF 407 as is performed in the art, as described e.g. from step 3 and onwards in FIG. 4.9.1.3.2-1 of 3GPP TS 23.502, version 1.0.0.

Advantageously, embodiments discussed with reference to FIG. 4 provide a method for delivering to the target AMF 307 information regarding which network slice(s) are suitable to handle the established PDN connection(s) of the UE 401 used in a non-slicing supporting source network (5GS/EPS/GPRS (“General Packet Radio Service”)).

This feature enables a) preserving PDU sessions/PDN connections at mobility (session continuity or service continuity) in a network without homogeneous slicing support, and b) that the selected target AMF 407 is the best suited AMF to fulfill the requirement of enabling traffic isolation across slices.

Additionally, the proposed solution allows for the provisioning of network slice related information (such as the NSSP) in the UE across a non-slice-supporting network, thereby avoiding external provisioning systems.

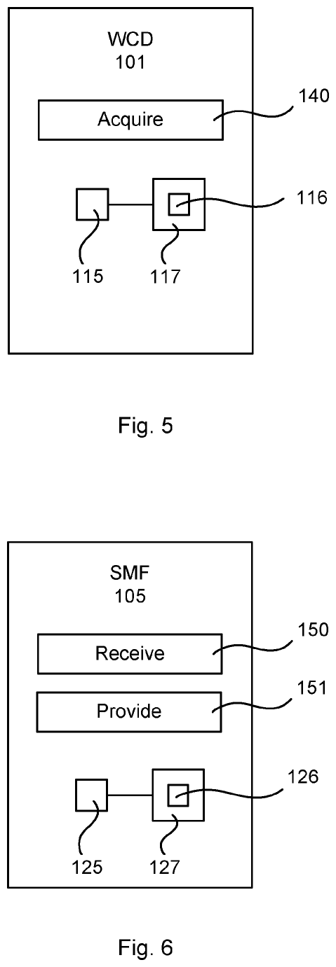

FIG. 5 illustrates a wireless communication device (WCD) 101 according to an embodiment. The steps of the method performed by the wireless communication device 101 of enabling establishing of connection for packet data transfer according to embodiments are in practice performed by a processing unit 115 embodied in the form of one or more microprocessors arranged to execute a computer program 116 downloaded to a suitable storage volatile medium 117 associated with the microprocessor, such as a Random Access Memory (RAM), or a non-volatile storage medium such as a Flash memory or a hard disk drive. The processing unit 115 is arranged to cause the wireless communication device 101 to carry out the method according to embodiments when the appropriate computer program 116 comprising computer-executable instructions is downloaded to the storage medium 117 and executed by the processing unit 115. The storage medium 117 may also be a computer program product comprising the computer program 116. Alternatively, the computer program 116 may be transferred to the storage medium 117 by means of a suitable computer program product, such as a Digital Versatile Disc (DVD) or a memory stick. As a further alternative, the computer program 116 may be downloaded to the storage medium 117 over a network. The processing unit 115 may alternatively be embodied in the form of a digital signal processor (DSP), an application specific integrated circuit (ASIC), a field-programmable gate array (FPGA), a complex programmable logic device (CPLD), etc.

The wireless communication device 101 comprises transmitting means 140 adapted to transmit, to a mobility management node, during the establishment of a packet data connection, an identifier of the established connection, and an S-NSSAI associated with the established connection.

The transmitting means 140 may comprise a communications interface for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

FIG. 6 illustrates a session management function (SMF) 105 according to an embodiment. The steps of the method performed by the session management function 105 of enabling establishment of connection for packet data transfer of a wireless communication device according to embodiments are in practice performed by a processing unit 125 embodied in the form of one or more microprocessors arranged to execute a computer program 126 downloaded to a suitable storage volatile medium 127 associated with the microprocessor, such as a Random Access Memory (RAM), or a non-volatile storage medium such as a Flash memory or a hard disk drive. The processing unit 125 is arranged to cause the session management function 105 to carry out the method according to embodiments when the appropriate computer program 126 comprising computer-executable instructions is downloaded to the storage medium 127 and executed by the processing unit 125. The storage medium 127 may also be a computer program product comprising the computer program 126. Alternatively, the computer program 126 may be transferred to the storage medium 127 by means of a suitable computer program product, such as a Digital Versatile Disc (DVD) or a memory stick.

As a further alternative, the computer program 126 may be downloaded to the storage medium 127 over a network. The processing unit 125 may alternatively be embodied in the form of a digital signal processor (DSP), an application specific integrated circuit (ASIC), a field-programmable gate array (FPGA), a complex programmable logic device (CPLD), etc.

The a session management function 105 comprises receiving means 150 adapted to receive a request to establish a packed data connection for a wireless communication device, and providing means 151 adapted to provide the wireless communication device with network slicing information enabling the wireless communication device to acquire S-NSSAI associated with the connection being established.

The means 150, 151 may comprise a communications interface for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

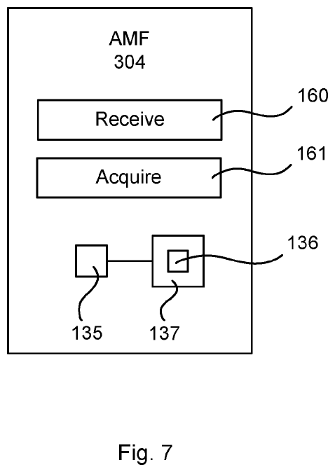

FIG. 7 illustrates an access and mobility management function (AMF) 304 according to an embodiment. The steps of the method performed by the access and mobility management function 304 of enabling handover of a wireless communication device according to embodiments are in practice performed by a processing unit 135 embodied in the form of one or more microprocessors arranged to execute a computer program 136 downloaded to a suitable storage volatile medium 137 associated with the microprocessor, such as a Random Access Memory (RAM), or a non-volatile storage medium such as a Flash memory or a hard disk drive. The processing unit 135 is arranged to cause the access and mobility management function 304 to carry out the method according to embodiments when the appropriate computer program 136 comprising computer-executable instructions is downloaded to the storage medium 137 and executed by the processing unit 135. The storage medium 137 may also be a computer program product comprising the computer program 136. Alternatively, the computer program 136 may be transferred to the storage medium 137 by means of a suitable computer program product, such as a Digital Versatile Disc (DVD) or a memory stick. As a further alternative, the computer program 136 may be downloaded to the storage medium 137 over a network. The processing unit 135 may alternatively be embodied in the form of a digital signal processor (DSP), an application specific integrated circuit (ASIC), a field-programmable gate array (FPGA), a complex programmable logic device (CPLD), etc.

The access and mobility management function 304 comprises receiving means 160 adapted to receive a request for handover comprising a TAI designating a target AMF to which the wireless communication device may be handed over, and acquiring means 161 adapted to acquire an identifier of at least one established packet data connection to be handed over, and an S-NSSAI associated with said at least one established packet data connection to be handed over.

The means 160, 161 may comprise a communications interface for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

The invention has mainly been described above with reference to a few embodiments. However, as is readily appreciated by a person skilled in the art, other embodiments than the ones disclosed above are equally possible within the scope of the invention, as defined by the appended patent claims.

1-54. (canceled)

55. A method performed by a wireless communication device for enabling establishment of a connection for packet data transfer, the method comprising:
during the establishment of the connection, transmitting to a mobility management node an identifier of the established connection and a Single Network Slice Selection Assistance Information (S-NSSAI) associated with the established connection.

56. The method of claim 55, wherein the wireless communication device is provisioned with the S-NSSAI before the establishing of the connection.

57. The method of claim 55, further comprising:
transmitting, to the mobility management node in a target communication network, a request to establish the connection; and
receiving, from the mobility management node, network slicing information enabling the wireless communication device to acquire the S-NSSAI associated with the connection being established.

58. A method performed by a Session Management Function for enabling establishment of a connection for packet data transfer of a wireless communication device, the method comprising:
receiving a request to establish the connection for the wireless communication device; and
providing the wireless communication device with network slicing information enabling the wireless communication device to acquire Single Network Slice Selection Assistance Information (S-NSSAI) associated with the connection being established.

59. A method for enabling a handover of a wireless communication device, the method comprising:
receiving a request for handover comprising a Tracking Area Identity (TAI) designating a target Access and Mobility Management function (AMF) to which the wireless communication device may be handed over; and
acquiring an identifier of at least one established packet data connection to be handed over, and a Single Network Slice Selection Assistance Information (S-NSSAI) associated with the at least one established packet data connection to be handed over.

60. The method of claim 59, wherein the request for handover comprises the identifier of the at least one established connection and the S-NSSAI associated with the at least one established packet data connection to be handed over.

61. The method of claim 59, wherein the acquiring comprising:
fetching the identifier of the at least one established connection and the S-NSSAI associated with the at least one established packet data connection to be handed over from a Unified Data Management (UDM) function.

62. The method of claim 59, wherein the request for handover comprises a priority indicator configured to indicate an order of priority among packet data connections in case a plurality of packet data connections are established and not all of the established packet data connections can be handled by the target AMF at handover.

63. The method of claim 62, wherein the priority indicator further indicates order of priority for any S-NSSAI yet without an active packet data connection.

64. A wireless communication device configured to enable establishing of connection for packet data transfer, the wireless communication device comprising:
a processing unit; and
a memory, the memory containing instructions executable by the processing unit, whereby the wireless communication device is operative to:
transmit, to a mobility management node, during the establishment of the connection, an identifier of the established connection and a Single Network Slice Selection Assistance Information (S-NSSAI) associated with the established connection.

65. The wireless communication device of claim 64, wherein the wireless communication device is provisioned with the S-NSSAI before the establishing of the connection.

66. The wireless communication device of claim 64, being operative to:
transmit, to the mobility management node in a target communication network, a request to establish the connection; and
receive, from the mobility management node, network slicing information enabling the wireless communication device to acquire the S-NSSAI associated with the connection being established.

67. A Session Management Function configured to enable establishment of connection for packet data transfer of a wireless communication device, comprising:
a processing unit; and
a memory, the memory containing instructions executable by the processing unit, whereby the Session Management Function is operative to:
receive a request to establish the connection for the wireless communication device; and
provide the wireless communication device, with network slicing information enabling the wireless communication device to acquire Single Network Slice Selection Assistance Information (S-NSSAI) associated with the connection being established.

68. An Access and Mobility Management function (AMF) configured to enable handover of a wireless communication device, comprising:
a processing unit; and
a memory, the memory containing instructions executable by the processing unit, whereby the Access and Mobility Management function is operative to:
receive a request for handover comprising a Tracking Area Identity (TAI) designating a target AMF to which the wireless communication device may be handed over; and
acquire an identifier of at least one established packet data connection to be handed over, and a Single Network Slice Selection Assistance Information (S-NSSAI) associated with the at least one established packet data connection to be handed over.

69. The Access and Mobility Management function of claim 68, the request for handover being configured to comprise the identifier of the at least one established connection and the S-NSSAI associated with the at least one established packet data connection to be handed over.

70. The Access and Mobility Management function of claim 68, being operative to:
fetch the identifier of the at least one established connection and the S-NSSAI associated with the at least one established packet data connection to be handed over from a Unified Data Management, UDM, function.

71. The Access and Mobility Management function of claim 68, the request for handover being configured to comprise a priority indicator configured to indicate an order of priority among packet data connections in case a plurality of packet data connections are established and not all of the established packet data connections can be handled by the target AMF at handover.
